(19) United States
(12) Patent Application Publication
(10) Pub. No.: US 2005/0171857 A1
(43) Pub. Date: Aug. 4, 2005

(54) Multifunctional kiosk

(76) Inventor: Rida Belkoura, Sterling, VA (US)

Correspondence Address: PERMAN & GREEN, 425 POST ROAD, FAIRFIELD, CT, 06824, US

(21) Appl. No.: 10/768,645

(22) Filed: Jan. 30, 2004

(51) Int. Cl. G06F 17/60

(52) U.S. Cl. 705/26

(57) ABSTRACT

A kiosk for providing multiple functions includes a communications port, a microprocessor, a user interface, and a payment device. The microprocessor is operable to connect to a service provider through the communications port and provide multiple functions and services to a user including advertisements, broadcast programs, the ability to purchase merchandise, and the ability to purchase postage.

### BACKGROUND OF THE INVENTION

1. Field of the Invention

The present invention relates to a automated, interactive kiosk for dispensing postage and having additional capabilities and functions.

2. Brief Description of Related Developments

Kiosks are generally known to provide a specific service, such as dispensing postage or providing internet access. It would be advantageous to provide a kiosk with multiple capabilities where a person might have access to a large number of services.

### SUMMARY OF THE INVENTION

The present invention is directed to a kiosk with multiple, value added capabilities. These might include reception of entertainment broadcasts, advertisements, both passive and interactive, including non-moving poster style advertisements and video clips, the ability to purchase various merchandise, the ability to play games, and other features.

In one embodiment the kiosk provides multiple functions and includes a communications port, a microprocessor, a user interface, and a payment device. The microprocessor is operable to connect to a service provider through the communications port and provide multiple functions and services to a user including advertisements, broadcast programs, the ability to purchase merchandise, and the ability to purchase postage.

### BRIEF DESCRIPTION OF THE DRAWINGS

The foregoing aspects and other features of the present invention are explained in the following description, taken in connection with the accompanying drawings, wherein:

FIG. 1 shows a block diagram of a system suitable for practicing the invention; and

FIG. 2 shows a general block diagram of a kiosk for providing multiple functionality.

### DETAILED DESCRIPTION OF THE PREFERRED EMBODIMENTS

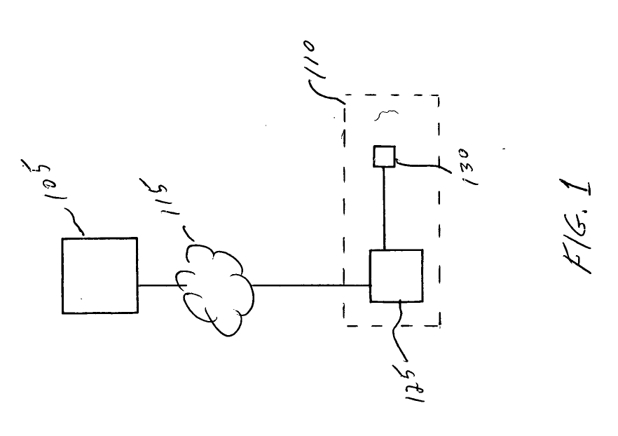

FIG. 1 shows a block diagram of a system 100 suitable for practicing the invention disclosed herein. Although the present invention will be described with reference to the embodiment shown in the drawings, it should be understood that the present invention can be embodied in many alternate forms of embodiments. In addition, any suitable size, shape or type of elements or materials could be used.

System 100 includes a kiosk 105, connected to a service provider infrastructure 110 through a network 115. The kiosk 105 generally provides postal services and additional functions, for example, postage for application to a finished mail piece, tickets allowing admission to an event or allowing the use of a service, and the like. The service provider infrastructure 110 provides updates, additional functions, replacement programs, data tables and other data and information to the kiosk 105.

It is a feature of the present invention to provide a kiosk with multiple, value added capabilities. These might include reception of entertainment broadcasts, advertisements, both passive and interactive, including non-moving poster style advertisements and video clips, the ability to purchase various merchandise, the ability to play games, and other features.

The service provider infrastructure 110 include a server 125 and a database 130 for storing programs and information required to provide functionality to the kiosk 105. System 100 may include other suitable components or functions for implementing the present invention.

Referring to FIG. 1 in greater detail, server 125 is coupled to the network 115. One or more devices for providing services to users in public places, in this example kiosk 105, are also coupled to the network 115, and may communicate bi-directionally through the network 115 with server 125. While a single server 125 is shown, server 125 may represent a plurality of servers, and these servers may be situated at a single location, or they may be widely distributed and remotely sited. For example, a plurality of distributed servers 125 may be used for servicing kiosks 105 in different geographic locations, according to particular local regulations, such as North America, South America, Europe, Africa, Japan and Southeast Asia. Alternately, a single server 125 can be used for servicing all kiosks 105. The kiosk may access any number of services, generally through server 125 or directly through network 115.

Server 125 may also include or be connected to one or more databases 130 that may store, in addition to operating programs, data related to the status, capabilities, characteristics or other information about the one or more kiosks 105. The one or more databases 130 may be centralized at a specific location or may be distributed among a number of distributed computers.

Network 115 may include any suitable communications network, for example, the Public Switched Telephone Network (PSTN), a wireless network, a wired network, a Local Area Network (LAN) a Wide Area Network (WAN), virtual private network (VPN) etc. Kiosk 105 may communicate with service provider infrastructure 110 using any suitable protocol, or modulation standard, for example, X.25, ATM, TCP/IP, V.34, V.90, etc. The kiosk 105 may access any number of services through network 115.

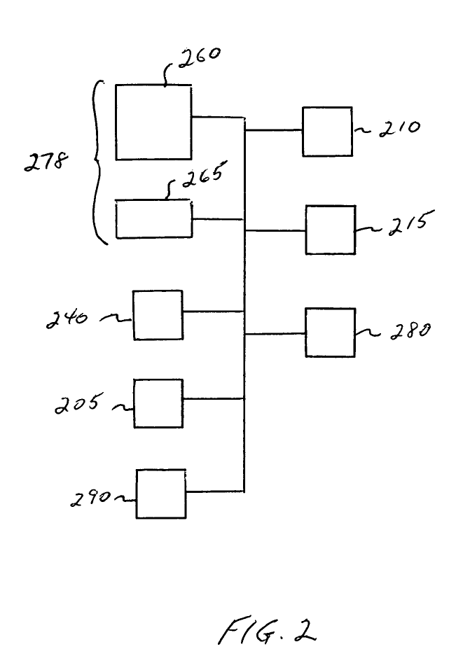

FIG. 2 shows a general block diagram of kiosk 105. Kiosk 105 may include a communications port 205 and a microprocessor 210 for performing various functions related to providing services to users according to programs stored in a storage device 215. Some of these functions or subsets of these functions may be grouped within a secure perimeter as what is commonly referred to as a Postal Security Device (PSD) 290. The kiosk may also include a user interface 278, generally comprising a display 260 and an input device 265, for example, a keyboard. The kiosk may also include a printer 240 and a payment device 280, for example, a mechanism for receiving coins and currency, or for reading credit and debit cards.

Microprocessor 210 typically performs electronic operations for controlling kiosk 105. These may include operating a franking function in conjunction with PSD 290 and providing access to various services through communications port 205. The franking functions typically include marking items with indicia and reporting the number of items, value marked and other parameters to the service provider infrastructure 110.

The kiosk 105 may also have or be integral to a device for marking objects with indicia and for general printing, shown in this embodiment as the above mentioned printer 240.

According to the present invention, the kiosk provides a wide variety of services and functions in addition to dispensing postage. For example, the kiosk may provide access to any number of broadcast, satellite, or cable programs. A user wishing to view, for example, a particular television program would use display 260 and input device 265 to navigate through a variety of broadcast, satellite, or cable programs, select one, pay for the service through payment device 280 and watch the program. A user may also access radio or other types of programs in a similar manner. The kiosk might also provide internet access, for example, for a charge based on access time.

In one embodiment, the kiosk displays movie advertisements, and a user, using the user interface 278 selects a particular movie preview for viewing through the kiosk. A user may also be provided with the ability to purchase the movie, for example on DVD or on video tape. A user may also be provided with the ability to listen to preview music clips and to purchase music, either in the form of downloads through communications port 205, or in the form of hard media such as a CD.

In another embodiment, the kiosk 105 provides a shopping facility where a user may view and purchase any number and type of products, for example, consumer goods.

In another embodiment, the kiosk 105 provides access to a particular locality's department of motor vehicles, and allows a user to perform all the functions usually associated with brick and mortar department of motor vehicle facilities. In particular, a user may be able to update information, pay fees, or print forms if desired.

The kiosk 105 may also provide ticketing services for any number of entertainment venues and for transportation such as trains and subways. In another embodiment, the kiosk may provide the ability to purchase and print money orders or other types of secured drafts.

In a further embodiment, the kiosk 105 may provide a gaming facility where a user may play any number of games, either alone, or interactively with other participants through other kiosks or through various internet web sites.

When the kiosk 105 is idle, it may revert to a type of screen saver operation where a number of different advertisements may be displayed in a sequential fashion. The advertisements may also include video clips related to the product, service, or entity being advertised. In addition, the kiosk may display public service announcements or general information when idle.

Thus, the service provider infrastructure 110, through the server 125 makes decisions about which additional functions and options are available for the franking machine, and which revisions and additional programs may be required to provide the additional functions and options. The service provider infrastructure 110 then makes further decisions regarding the order that the revisions and programs are to be performed in order to install the new functions and options.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. A kiosk for providing multiple functions comprising:
a communications port;
a microprocessor;
a user interface; and
a payment device,
wherein the microprocessor is operable to connect to a postal service provider infrastructure through the communications port and provide multiple functions and services to a user,
the multiple functions and services including advertisements, broadcast programs, the ability to purchase merchandise, the ability to preview and purchase movies, and the ability to purchase postage.

2. The kiosk of claim 1, wherein the user interface operates to allow a user to navigate through a variety of programs for viewing.

3. The kiosk of claim 1, wherein the microprocessor is operable to provide a user with the ability to listen to music clips and to purchase music.

4. The kiosk of claim 1, wherein the purchased music may be in the form of a download.

5. The kiosk of claim 1, wherein the microprocessor is operable to provide a user with access to a particular locality's department of motor vehicles.

6. The kiosk of claim 1, wherein the microprocessor is operable to provide a user with ticketing services for entertainment venues and transportation.

7. The kiosk of claim 1, wherein the user interface operates to display advertisements when the kiosk is idle.
